(19) United States
(12) Patent Application Publication
(10) Pub. No.: US 2020/0102763 A1
(43) Pub. Date: Apr. 2, 2020

(54) THREE-DIMENSIONAL CONSTRUCTION METHOD AND THREE-DIMENSIONAL CONSTRUCTION SYSTEM

(71) Applicant: Maruichi co., ltd., Murakami (JP)

(72) Inventor: Noboru Misaki, Murakami (JP)

(21) Appl. No.: 16/504,818

(22) Filed: Jul. 8, 2019

(30) Foreign Application Priority Data
Sep. 27, 2018 (JP) 2018-182615

(51) Int. Cl. E04G 21/32; G05D 1/10; A62B 35/00; B66D 3/06

(52) U.S. Cl. CPC E04G 21/3276; B66D 3/06; A62B 35/0068; G05D 1/10

(57) ABSTRACT

A three-dimensional construction method comprises: installing two pulleys at a predetermined interval in a substantially horizontal direction, installing two rope winders at downward position by predetermined distances with respect to the installation positions of the pulleys, respectively, and passing two ropes through the pulleys, respectively, one ends of the two ropes being connected to the rope winders, respectively, and the other ends thereof being connected to a worker's wearing tool, wherein the feeding and winding lengths and winding speeds of the two ropes of the two winding machines, respectively, are controlled to enable the worker to move to a desired position, in a space defined by positions where the pulleys are installed, and positions in contact with the ground below positions where the pulleys are installed.

### CROSS-REFERENCE TO RELATED APPLICATION

The present application claims priority to Japanese Patent Application No. 2018-182615, filed on Sep. 27, 2018, which is incorporated herein by reference in its entirety.

### TECHNICAL FIELD

The present invention relates to a three-dimensional construction method and a three-dimensional construction system, and more particularly to a construction method and system that can freely expand degrees of freedom of the construction and shaping by workers in the air using a fiber rope or a wire rope (rope, wire, etc. hereinafter collectively referred to as “rope”).

### BACKGROUND ART

Conventionally, when constructing building structures or workpieces such as houses, buildings, bridges and dams (hereinafter, these are collectively referred to as “structure”), scaffoldings or lifting devices such as gondolas (hereinafter collectively referred to as “temporary scaffolding, etc.”) are installed, especially for workers to work at a high position or for use as a pathway.

Installation of temporary scaffolding, etc. requires corresponding cost and time, and falling accidents may occur during and after construction of temporary scaffolding, etc. Furthermore, there is a risk that an impact of an accident may be enormous due to forgetting to wear a life rope such as a lanyard.

For example, for a structure having a complicated structure, a technology is disclosed that enables handling the situation without reassembling a foothold by using a mobile work vehicle (for example, Patent Literature 1).

Also, a technology is disclosed for repairing a roof and preventing damage to a house when it falls, without requiring a foothold, by installing a rope to the roof along the outer wall of the house (for example, Patent Literature 2).

### PRIOR ART LITERATURE

### Patent Literature

[Patent Literature 1] Japanese Patent Publication No. 2018-112027

[Patent Literature 2] Japanese Patent Publication No. 2013-144873

### DETAILED DESCRIPTION OF THE INVENTION

### Technical Problem

However, in Patent Literature 1 described above, installation of the scaffold is still essential, and it is difficult to radically solve the cost problem. Moreover, although Patent Literature 2 makes a scaffold unnecessary, it is a technology specialized in repairing the roof of a house and is not solving the technical problem of providing a technique which corresponds widely to construction of a structure.

In this manner, the technique capable of maintaining degrees of freedom of construction of a structure, while making installation of a temporary scaffold unnecessary, is not disclosed.

Thus, an object of the present invention is to provide an unprecedented construction method and system which can epochally improve degrees of freedom of the construction.

### Technical Solution

In one embodiment of the invention, there is provided a three-dimensional construction method for performing construction work in a three-dimensional space, the method comprising

installing first and second pulleys at a predetermined interval in a substantially horizontal direction of a same or different structures,

installing first and second rope winders at downward positions by predetermined distances with respect to the installation positions of the first and second pulleys of the structure, and

passing first and second ropes through the first and second pulleys, respectively, one ends of the first and second ropes being connected to the first and second rope winders, respectively, and the other ends thereof are connected to a worker's wearing tool,

wherein feeding and winding lengths and feeding and winding speeds of each of the first and second ropes of the first and second winding machines are controlled so that the worker can move to a desired position, in a space defined by positions in contact with the ground below the positions where the first and second pulleys are installed, and the positions where the first and second pulleys of the structure are installed.

In another embodiment of the invention, there is provided a three-dimensional construction system for performing construction work in a three-dimensional space, having:

first and second rigging pulleys installed at a predetermined interval in a substantially horizontal direction on a same or different structures,

first and second rope winders installed at downward positions by predetermined distances with respect to the installation positions of the first and second pulleys of the structure, respectively,

first and second ropes passed through the first and second pulleys, respectively, and

a control device for controlling feedings and windings of the first and second ropes of the first and second rope winders, respectively,

wherein one ends of the first and second ropes are connected to the first and second rope winders, respectively, and the other ends thereof are connected to a worker's wearing tool, and

wherein the control device controls the feeding and winding lengths and the feeding and winding speeds of each of the first and second ropes of the first and second winding machines, respectively, are controlled so that the worker can move to a desired position, in a space defined by positions where the first and second pulleys are installed, and positions in contact with the ground below positions where the first and second pulleys of the structure are installed.

### Advantageous Effects

According to the present invention, it is possible to provide an unprecedented construction method and system capable of epochally improving degrees of freedom of construction.

### BRIEF DESCRIPTION OF DRAWINGS

FIG. 1 is a view showing an example of a configuration of a three-dimensional space construction method and system according to a first embodiment of the present invention.

FIG. 2 is a view showing an example of a movement instruction device by a worker, among the three-dimensional space construction method and system according to the first embodiment of the present invention.

FIG. 3 is a flowchart illustrating movement control of a worker in a three-dimensional space according to the first embodiment of the present invention.

FIG. 4 is a view showing an example of movement of a worker in a three-dimensional space, among the three-dimensional space construction method and system according to the first embodiment of the present invention.

FIG. 5 is a view showing another example of the movement of the worker in a three-dimensional space among the three-dimensional space construction method and system according to the first embodiment of the present invention.

FIG. 6 is a view showing another example of the configuration of the three-dimensional space construction method and system according to the first embodiment of the present invention.

FIGS. 7A and 7B are views showing examples of the configuration of the three-dimensional space construction method and system according to a second embodiment of the present invention.

FIG. 8 is a view which illustrates a concept of configuration of the three-dimensional space construction method and system due to a third embodiment of the present invention.

FIG. 9 is a view showing an example of the configuration of the three-dimensional space construction method and system according to the third embodiment of the present invention.

FIG. 10 is a view showing an example of the configuration of the three-dimensional space construction method and system according to a fourth embodiment of the present invention.

FIG. 11 is a view showing an example of the three-dimensional space construction method and system according to a fifth embodiment of the present invention.

FIGS. 12A and 12B is views showing examples of the configuration of the three-dimensional space construction method and system according to the fifth embodiment of the present invention.

### DETAILED DESCRIPTION OF THE EMBODIMENTS

Contents of embodiments of the present invention will be listed and described. The three-dimensional space construction method and system according to embodiments of the present invention are as follows.

[Item 1]

A three-dimensional construction method for performing construction work in a three-dimensional space, the method comprising

installing first and second pulleys at a predetermined interval in a substantially horizontal direction of a same or different structures,

installing first and second rope winders at downward positions by predetermined distances with respect to the installation positions of the first and second pulleys of the structure, respectively, and

passing first and second ropes through the first and second pulleys, respectively, one ends of the first and second ropes being connected to the first and second rope winders, respectively, and the other ends thereof being connected to a worker's wearing tool,

wherein the feeding and winding lengths of the first and second ropes and feeding and winding speeds of the first and second winding machines are controlled so that the worker can move to a desired position, in a space defined by the positions where the first and second pulleys are installed, and positions in contact with the ground below positions where the first and second pulleys of the structure are installed.

[Item 2]

The three-dimensional construction method according to Item 1, wherein the different structures are first and second struts installed substantially upright to the ground.

[Item 3]

The three-dimensional construction method according to Item 2, wherein the first and second rope winders are installed at the positions contacting the ground of the first and second struts, respectively.

[Item 4]

The three-dimensional construction method according to Item 2, wherein the first and the second struts are connected by a third strut.

[Item 5]

The three-dimensional construction method according to Item 1, comprising:

installing third and fourth rigging pulleys at a predetermined interval in a substantially horizontal direction of the structure,

installing third and fourth rope winders at downward positions by predetermined distances with respect to the installation positions of the first and second pulleys of the structure, and

passing third and fourth ropes through the third and fourth pulleys, respectively,

wherein one ends of the third and fourth ropes are connected to the third and fourth rope winders, respectively.

[Item 6]

The three-dimensional construction method according to Item 5, wherein the other ends of the third and fourth ropes are connected to a transport cargo.

[Item 7]

The three-dimensional construction method according to Item 1, wherein a fixing portion for fixing a rope for preventing a worker from swinging in a direction substantially orthogonal to the space is installed at any position of a surface substantially orthogonal to the space.

[Item 8]

A three-dimensional construction system for performing construction work in a three-dimensional space, having:

first and second rigging pulleys installed at a predetermined interval in a substantially horizontal direction on a same or different structures,

first and second rope winders installed at downward positions by predetermined distances with respect to the installation positions of the first and second pulleys of the structure,

first and second ropes passed through the first and second pulleys, respectively, and

a control device for controlling the feedings and windings of the first and second ropes of the first and second rope winders, respectively,

wherein one ends of the first and second ropes are connected to the first and second rope winders, respectively, and the other ends thereof are connected to a worker's wearing tool, and wherein the control device controls the feeding and winding lengths and the feeding and winding speeds of each of the first and second ropes of the first and second winding machines, respectively, are controlled so that the worker can move to a desired position, in a space defined by positions where the first and second pulleys are installed, and positions in contact with the ground below positions where the first and second pulleys of the structure are installed.

[Item 9]

The three-dimensional construction system according to Item 8, wherein the different structures are first and second struts installed substantially upright to the ground.

[Item 10]

The three-dimensional construction system according to Item 9, wherein the first and second rope winders are installed at positions contacting the ground of the first and second struts, respectively.

[Item 11]

The three-dimensional construction system according to Item 9, further having a third strut connecting with the first and second struts.

[Item 12]

The three-dimensional construction system according to Item 8, having:

third and fourth pulleys installed at a predetermined interval in a substantially horizontal direction of the structure;

third and fourth rope winders installed at downward positions by predetermined distances with respect to the installation positions of the third and fourth pulleys of the structure, respectively, and

third and fourth ropes passed through the third and fourth pulleys, respectively,

wherein one ends of the third and fourth ropes are respectively connected to the third and fourth rope winders, respectively.

[Item 13]

The three-dimensional construction system according to Item 12, wherein the other ends of the third and fourth ropes are connected to a transport cargo.

[Item 14]

The three-dimensional construction system according to Item 8, wherein a fixing portion for fixing a rope for preventing a worker from swinging in a direction substantially orthogonal to the space is installed at any position of a surface substantially orthogonal to the space.

### First Embodiment

Hereinafter, the three-dimensional space construction method and system according to a first embodiment of the present invention will be described with reference to the figures.

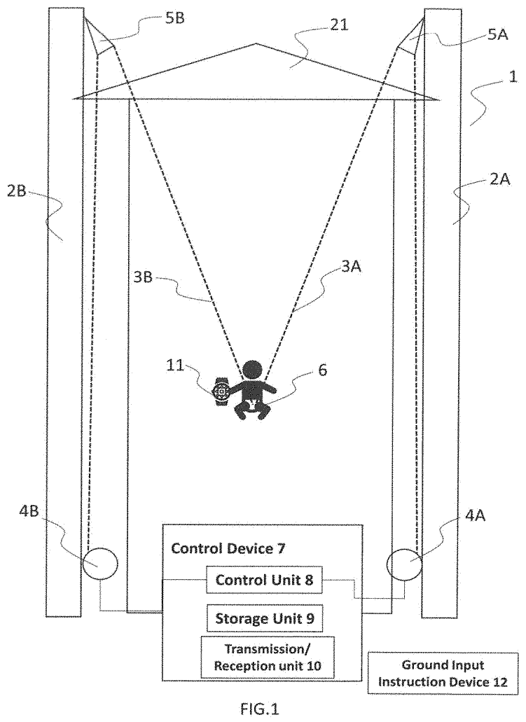

FIG. 1 is a view showing an example of a configuration of the three-dimensional space construction method and system according to the first embodiment of the present invention.

In FIG. 1, first, a three-dimensional space construction system 1 has a pair of struts 2A and 2B installed substantially upright to the ground. The installation interval of the struts 2A and 2B can be a predetermined distance depending on the size of a construction object (for example, structure 21) and the construction range. The strut may be, for example, a rectangular or cylindrical wooden or steel strut. Similarly, the length in the height direction of the strut may be set to a predetermined length in accordance with the size of a construction object and the construction range.

Further, the struts can be fixed to the ground in a known manner, but for example, by providing a wheel at the ground side end of the strut, the strut itself can be made to travel freely. Moreover, it can also move together with the work vehicle by loading it on a cargo bed of a mobile work vehicle. Alternatively, a mobile crane vehicle can be used instead of the strut. Furthermore, if a pulley and a rope winding machine described later can be installed to a part of construction object, it is also possible not to use a strut.

Further, the three-dimensional space construction system 1 has rope winding machines 4A and 4B (for example, drums) capable of winding and feeding the ropes, in the vicinity of the positions where the struts 2A and 2B contact with the ground. If rope winding machines 4A and 4B are located below the pulleys 5A and 5B described later, they may be fixed at any position of the struts 2A and 2B, respectively, or may be installed on the ground. As described later, in order to automatically control the winding and feeding of the rope, the rope winders 4A and 4B may preferably incorporate an electric motor and a counter and speedometer for counting the winding/feeding amount of the rope.

Further, the three-dimensional space construction system 1 has pulleys 5A and 5B at the upper ends of the struts 2A and 2B, respectively. For example, an anchor can be installed on the strut, and the pulley can be installed from the anchor through a connection member, or other methods can be used. As mentioned above, the pulleys 5A and 5B can be installed not only on the struts but also on the structure to be constructed.

Moreover, the three-dimensional space construction system 1 has ropes 3A and 3B. As the ropes 3A and 3B, ropes of any types and characteristics can be used, but those having strengths that can cope with a tensile force are preferable. The ropes 3A and 3B are passed through pulleys 5A and 5B, respectively, one ends of which are connected to winders 4A and 4B (hereinafter referred to as “drum”), respectively, and the other ends of which are connected to a wearing tool (for example, harness) of a worker 6.

In this manner, as the structure of the entire ropes, as one ends of the ropes 3A and 3B are connected to the drums at both ends while the other ends connected to the worker 6 in the middle, in the working space defined by the two points of the pulleys 5A and 5B of the structure 21, and the positions contacting the ground below the two points, a worker 6 operates so that the drums 4A and 4B wind or feed the ropes 3A and 3B, respectively, so that they can move freely.

In theory, several workers other than worker 6 wait on drums 4A and 4B, and the rope winding/feeding work is performed by the drum according to the instruction of the worker 6. Thus, it is possible to support the movement of the worker 6, but since the three-dimensional space construction system further includes a control device 7, the movement in the work space can be automatically performed.

The control device 7 at least includes a control unit 8, a storage unit 9, and a transmission/reception unit 10.

The control unit 8 is an arithmetic device that controls the operation of the entire system, controls transmission and reception of data between elements, and performs information processing and the like necessary for execution and authentication of an application. For example, the control unit 8 is a CPU (Central Processing Unit), and executes a program, etc. developed in a storage unit 9 to carry out each information processing.

The storage unit 9 includes a main storage configured of a volatile storage device such as DRAM (dynamic random access memory), and an auxiliary storage configured of a non-volatile storage device such as flash memory or HDD (hard disc drive). The memory is used as a work area, etc. of processor, and it stores BIOS (basic input/output system) that is executed when starting a server, various setting information, and the like.

Moreover, although not illustrated, the control device 7 can also have storage. The storage stores various programs such as application programs. A database (not shown) for storing data used for each process may be constructed in the storage.

The transmission/reception unit 10 connects the control device 7 to a network such as Internet. The transmission/reception unit 10 may include a short distance communication interface of Bluetooth (registered trademark) and BLE (Bluetooth Low Energy). When the worker 6 carries a movement instruction device 11 and instructs the control device to move in the work space, the transmission/reception unit 10 receives an instruction signal from the movement instruction device via network.

Moreover, although not illustrated, the control device 7 can also be provided with an input-output unit. In order for the worker to move in the work space, the input/output device is, for example, an information input device such as a keyboard and/or a mouse and/or a touch panel for inputting an instruction to operate a system, and an output device such as a display. Alternatively, it can be separately provided with an input instruction device 12 for instructing movement or other processing within the work space, particularly for an emergency.

Further, although not illustrated, the control device 7 can be commonly connected to the above-described respective elements, and can include, for example, a bus that transmits an address signal, a data signal, and various control signals.

Further, in FIG. 1, when the worker 6 performs construction work at the roof of the structure 21, in accordance with the construction system 1, temporary scaffolding becomes unnecessary. Thus, it becomes necessary to secure the workability of the worker and the safety accompanying it. Here, in order to secure the workability of the worker, a weight control device for the worker (not shown) can be provided. The weight control device is a device that reduces the weight of the worker with a rope, and for example, adds a weight control dial to an input instruction device 11 or an input instruction unit 12. When instructing to reduce the weight of worker to 50%, for example, the worker's weight of 80 kg is reduced up to 40 kg. For example, if the worker is standing on the roof, the worker's weight of 80 kg acts on the roof as it is in a state in which no tension is applied to the rope. By applying a tensile force in the direction opposite to gravity by the rope, it is possible to reduce the force acting on the roof and to adjust the force. The adjustment of the tensile force can be performed in cooperation with the control device 7 and the drums 4A and 4B. In this manner, by controlling the weight of the worker, the worker can construct the roof surface on a foothold with a feeling that the worker stands on a temporary scaffold, and can reduce its own weight, it is also possible to perform construction work on steep slope roofs.

Moreover, when the worker 6 performs work at a roof, in order to ensure the safety of the worker, the construction system 1 can be provided with a falling speed control device (not shown). The falling speed control device is a device capable of securing a low falling speed below a specified speed (for example, 1 m or less per second) even when fallen from the roof surface edge, and preventing a fall accident, and a winch with a braking mechanism, and the like can be used.

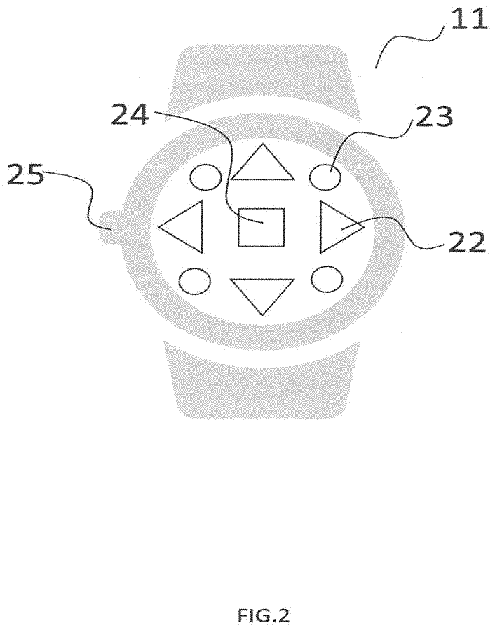

FIG. 2 is a view showing an example of a movement instruction device by a worker among the three-dimensional space construction method and system according to the first embodiment of the present invention. As shown in FIG. 2, the movement instruction device 11 can have, for example, a wristwatch-like form so that the worker can carry it. The movement instruction device 11 has an operation panel for instructing movement in the work space, and the operation panel may have, for example, a button 22 for instructing to move in the up and down (height) and horizontal direction with respect to the ground, a button 23 for instructing to move obliquely, a confirmation button 24 for confirming the instruction, and a moving speed adjustment button 25 for adjusting the moving speed.

In particular, in order to prevent an erroneous operation of the movement instruction, the movement instruction may be determined by simultaneously pressing a direction button 22 and a confirmation button 24. Also, for example, in order to cope with fine movement in the work space, the moving speed can be adjusted in the range of 0.1 m/s to 0.3 m/s in the low speed region. In addition, the moving speed can be adjusted to 1.0 m/s as a normal moving speed, and further to 2 m/s as a speed of moving at a high-speed (for professional). Further, according to the speed, it is also possible to allow the worker to instruct speed adjustments to multiple levels, for example, level 1 (0.1 m/s), level 2 (0.2 m/s), level 3 (0.3 m/s), level 4 (1.0 m/s), level 5 (2.0 m/s).

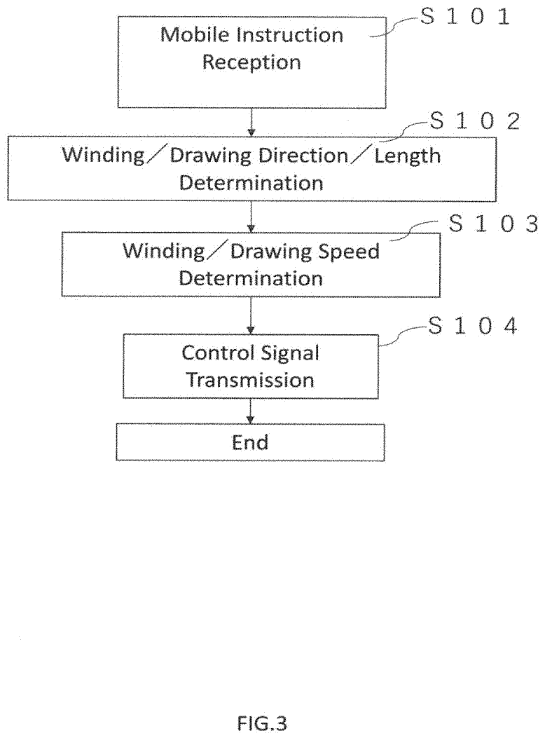

FIG. 3 is a view illustrating movement control of a worker in a three-dimensional space among the three-dimensional space construction method and system according to the first embodiment of the present invention.

As described above, the movement of the worker in the work space can be realized by processing by the program executed by the control unit 8 of the control device 7 and controlling the winding/feeding of the ropes by the drums in accordance with the instruction of the worker. Hereinafter, the processing performed by the control unit 8 will be described step by step with reference to FIGS. 3 to 5 as an example.

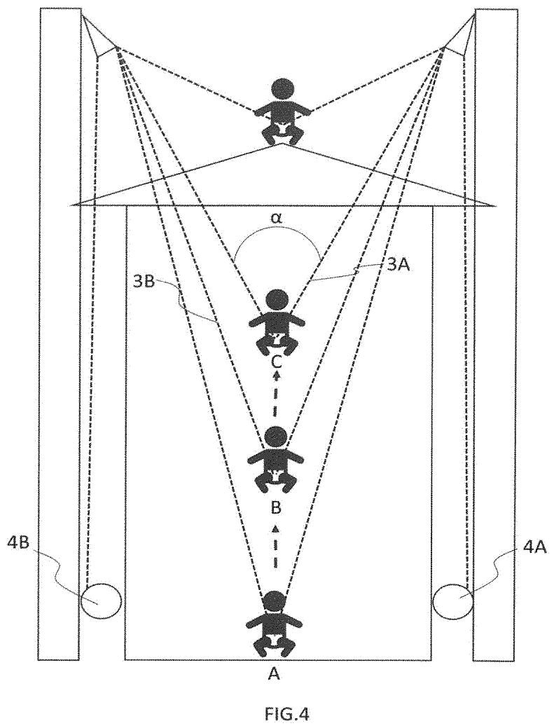

First, as shown in FIG. 4, for example, an instruction is given using an upward button 22 of the movement instruction device 11 so that the worker moves from the point A on the ground to a predetermined height B in the center of the work space to start construction work.

The instruction signal is received by the transmission/reception unit 10 of the control device 7 via a network (S101). The received instruction signal is transmitted to a control unit 8 in the control device 7.

The control unit 8 confirms the moving direction indicated by the instruction based on the instruction signal, and determines control of winding and feeding of the ropes 3A and 3B by the drums 4A and 4B, respectively, in accordance with the moving direction. First, each of the drums 4A and 4B determines whether to perform rope winding control or feeding control, and determines the rope winding/feeding length according to the movement distance (S102).

For example, as shown in FIG. 4, when the worker instructs to move from the point A to the point B in the upright direction, the control unit 8 determines that the drums 4A and 4B perform control to wind the ropes 3A and 3B respectively, and calculates and determines the winding lengths of the ropes according to the moving distance from the point A to the point B by comparing the lengths of the ropes 3A and 3B connecting the worker 6 from the pulleys 5A and 5B, respectively, before and after the movement.

Next, the control unit 8 determines the winding and feeding speeds of the ropes 3A and 3B by the drums 4A and 4B, respectively, according to the movement direction, based on the instruction signal (S103).

In the case of the example of FIG. 4, since the worker instructs to move from the point A to the point B or from the point B to the point C, the control unit 8 determines that the drums 4A and 4B wind the ropes 3A and 3B, respectively, at a constant speed. Here, the speed can also be adjusted in accordance with the instruction of the speed adjustment from the worker. The winding speed when instructing to move from the point B to the point C is also the same.

Next, the control unit 8 transmits a signal for controlling the winding/feeding directions/lengths and speeds of the ropes taken by the drums 4A and 4B to the drums 4A and 4B (S104).

In the example of FIG. 4, the control unit 8 transmits control signals to the drums 4A and 4B so that the drums 4A and 4B wind the ropes at the same speeds and by the calculated lengths. The drum 4A and the drum 4B operate to wind the ropes at instructed speeds and lengths based on the control signal.

Thereby, in FIG. 4, the ropes 3A and 3B are wound by the determined lengths at the same speeds, and the worker can move from the point A to the point B accordingly.

Here, when the worker tries to move to a position close to the height at which the rope 3A and the rope 3B become in an infinite horizontal relationship (for example, point C in FIG. 4), the tensile force on the rope 3A by the drum 4A and the tensile force on the rope 3B by the drum 4B are increased, and eventually, the strength of the rope is exceeded and the rope may break. Therefore, the control unit 8 can control to stop the winding of the rope by the drums 4A and 4B when, for example, the angle α formed by the ropes 3A and 3B becomes equal to or less than a predetermined angle (for example, 120° or less). Alternatively, a sensor is provided at a predetermined height position of the strut 2A or 2B to detect that the worker has risen to the predetermined height position, and control so that the worker stops the operation of the drums 4A and 4B.

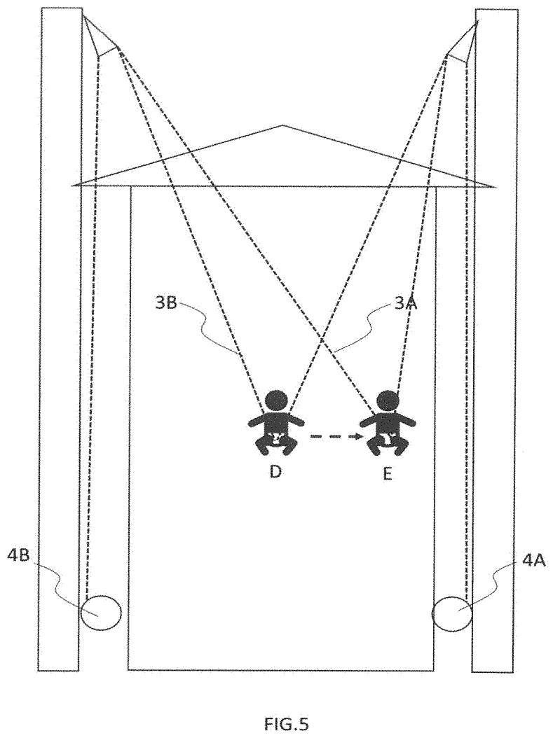

Also, as shown in FIG. 5, when the worker wants to move just beside (horizontal direction) from point D to point E and gives an instruction by means of a movement instruction device, the control unit 8 determines so that the drum 4A winds the rope 3A by an amount corresponding to the movement distance based on the instruction signal, and the drum 4B feeds the rope 3B by an amount corresponding to the movement distance. Further, here, if the winding speed of the rope 3A by the drum 4A and the feeding speed of the rope 3B by the drum 4B are equalized, it is difficult to move the workers horizontally, and thus it is necessary to control the winding speed of the drum 4A and the feeding speed of the drum 4B. The control unit 8 calculates the winding speed of the rope 3A by the drum 4A and the feeding speed of the rope 3B by the drum 4B, and transmits signals for controlling the drum 4A and the drum 4B to the drum 4A and the drum 4B, respectively. The drums 4A and 4B control to wind or feed the ropes at the instructed speeds and lengths based on the control signal (for example, in the case of the example shown in FIG. 5, it is controlled so that the feeding speed of the rope 3B by the drum 4B is faster than the winding speed of the rope 3A by the drum 4A). Thereby, in FIG. 5, the ropes 3A and 3B are wound up or fed by determined speeds and lengths, and the worker can move horizontally from point D to point E accordingly.

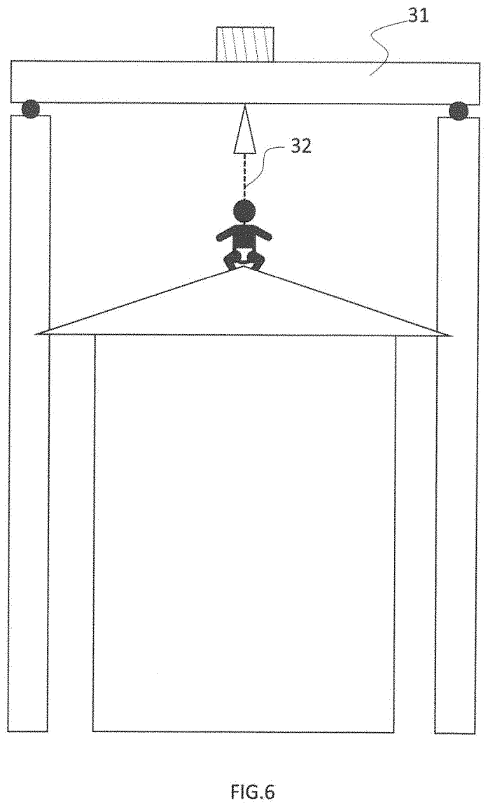

FIG. 6 is a view showing another example of the configuration of the three-dimensional space construction method and system according to the first embodiment of the present invention.

As shown in FIG. 6, a reinforcement member 31 which connects a strut 2A and a strut 2B of the three-dimensional space construction system 1 is further provided. The reinforcing member 31 may be, for example, square or circular member made of wood or steel, and those made from the same material as the struts 2A and 2B can be used. By providing the reinforcing member 31, the strength of the entire three-dimensional construction space system including the struts 2A and 2B can be enhanced.

In addition, the reinforcing member 31 can be used to provide a backup 32 for preventing the falling down of the worker due to rope breakage or the like.

As mentioned above, according to the three-dimensional construction method and system of this embodiment, it is possible to significantly improve degrees of freedom of construction while reducing the construction period by eliminating the construction of scaffolding, regardless of the height of the construction structure. Further, since wearing a rope, that is a safety device, is a precondition for work, it is possible to provide an innovative construction method and system without the possibility of an accident caused by forgetting to wear the safety device.

### Second Embodiment

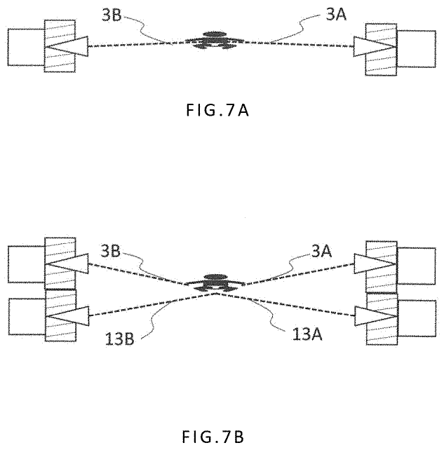

FIGS. 7A and 7B are views showing examples of the configuration of the three-dimensional space construction method and system according to a second embodiment of the present invention. Since the configuration of the construction system of the present embodiment other than those mentioned below is basically the same as that of the first embodiment, the description thereof will be omitted.

FIG. 7A is a diagram in which the three-dimensional space construction system according to the first embodiment is viewed from the right above. As described above, in the first embodiment, the construction system includes a pair of ropes 3A and 3B, and basically, the worker could move only within the range where the ropes 3A and 3B are provided. That is, when viewed from just above, it was possible to work in the range which reciprocates one straight line.

As shown in FIG. 7B, in the present embodiment, the three-dimensional space construction system 1 further includes another pair of ropes 13A and 13B. The other configuration is basically the same as the system configuration described in the first embodiment, and thus the description thereof will be omitted in this embodiment. However, when the ropes 13A and 13B are provided, the construction system includes a pair of struts, pulleys and drums.

In FIG. 7B, the worker is connected to the ropes 3A and 3B, but when the worker wants to move to the work space realized by the ropes 13A and 13B, the rope 3A is replaced by the rope 13A using a rope connector (for example, carabiner) of its own wearing tool (for example, harness). Furthermore, it becomes possible to move to the movable space by ropes 13A and 13B by changing rope 3B to rope 13B.

According to the three-dimensional space construction method and system of the present embodiment, degrees of freedom of construction can be further improved when more three-dimensional construction is required, such as when a construction object is a complicated structure.

### Third Embodiment

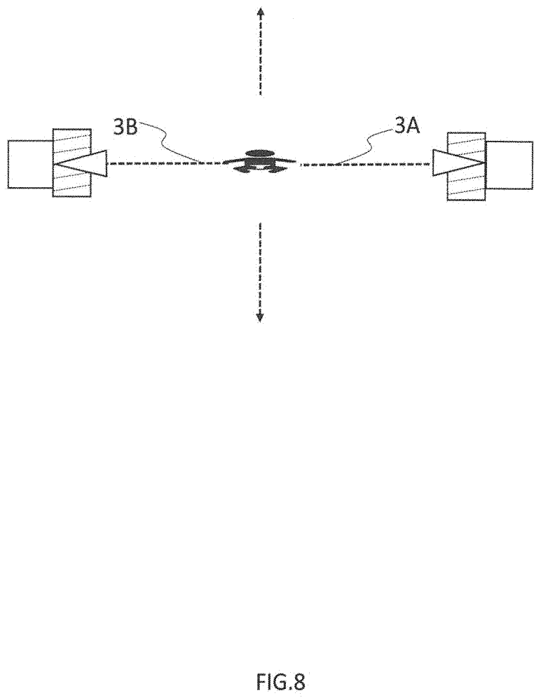

FIG. 8 is a view which illustrates a concept of configuration of the three-dimensional space construction method and system due to a third embodiment of the present invention. Since the configuration of the construction system of the present embodiment other than those mentioned below is basically the same as that of the first embodiment, the description thereof will be omitted.

In the system configuration according to the first and second embodiments, FIG. 8 shows a state of swinging in a direction substantially orthogonal (in the back and forth direction as viewed from the worker) to the work space where the worker can move (that is, the left and right direction viewed from the worker). In particular, when the worker performs a work, the vector in the horizontal direction causes the worker to swing, which may cause the work not to be performed smoothly. In addition, when the worker moves the work space, the front/rear swinging of the rope increases. As a result, there is a possibility that the movement may not go smoothly.

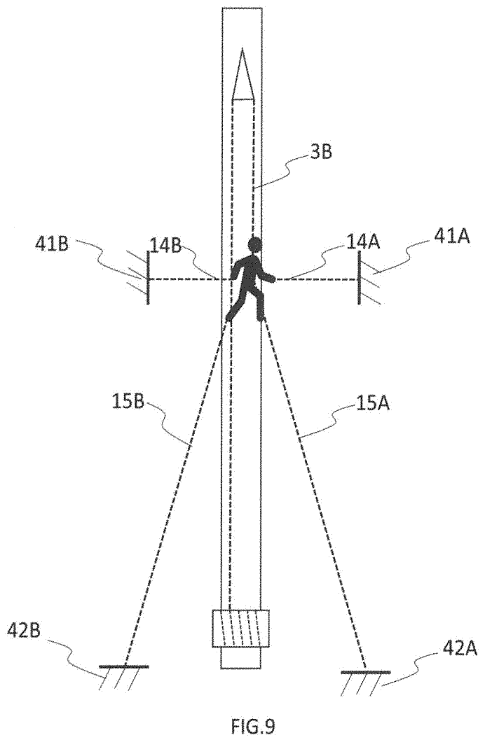

FIG. 9 is a view showing an example of the configuration of the three-dimensional space construction method and system according to the third embodiment of the present invention. In other words, in the three-dimensional space construction system according to this embodiment, fixing portions 41A, 41B, 42A and 42B (for example, anchor) for fixing ropes are provided at any position of the regions defined by the surface formed in the front and back direction as viewed from the worker, for example, at a position of the struts, the ground or the like. One ends of the ropes 14A and 14B, or 15A and 15B, for preventing the ropes 3A and 3B from swinging in the front/rear direction are connected to the fixing portions 41A and 41B or 42A and 42B, respectively, and the other ends thereof are connected to the worker's wearing tool (for example, harness). Since the purpose is to prevent swinging of the ropes 3A and 3B in the left and right directions as viewed from the worker which is caused in the front and rear directions as viewed from the worker. Thus, as long as it is an area defined by a surface configured in the front-rear direction as viewed from the worker, the installation position of the fixed part connecting the rope may be any position in the vertical (height) direction. Although not illustrated, it is also possible to provide a fixing portion on the upper side as viewed from the worker and provide an anti-swinging rope.

### Fourth Embodiment

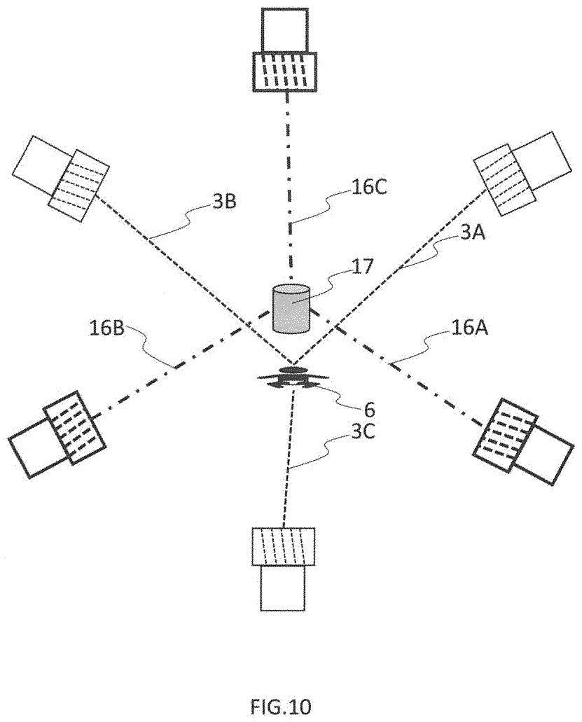

FIG. 10 is a view showing an example of the configuration of the three-dimensional space construction method and system according to a fourth embodiment of the present invention. The configuration of the construction system of the present embodiment other than those mentioned below is basically the same as that of the first embodiment, the description thereof will be omitted.

As a feature of this embodiment, the worker is connected by three ropes 3A, 3B, and 3C as shown in FIG. 10, and degrees of freedom of the construction space is becoming higher. That is, the worker can work in an entire horizontal plane where it is defined by the surrounding drums which feed/wind the ropes 3A, 3B and 3C, as shown in FIG. 10, in addition to the vertical (height) direction to the ground.

Furthermore, as a feature of the present embodiment, the construction system is provided with ropes 16A, 16B and 16C as shown in FIG. 10. One end of each rope is connected to each corresponding drum, and the other ends thereof are not connected to the worker but to a transport cargo. In particular, with regard to the transport cargo, the construction costs can be reduced because it is actively considered to use cranes instead of struts.

In the construction system of the present embodiment, in FIG. 10, when the worker moves in the construction space, the movement may be blocked by crossing the transport cargo rope. For example, in FIG. 10, it is assumed that the worker wants to move from the position on the rope 3C to the position of the rope 3A or 3B. At this time, since the ropes 3A or 3B crosses the transport ropes 16A or 16B, respectively, the ropes may be entangled if the worker tries to move any further, which causes a trouble in construction. Therefore, the worker can once remove only one of the ropes 3A to 3C connected to the harness and reconnect the removed ropes so as not to cross the transport ropes. In particular, even if the worker removes one rope, the remaining two are still connected, so the worker can perform a work on the attachment and detachment of the rope in a stable state. As described above, even if the worker's rope and the transport rope are provided as in this embodiment, the worker can perform construction work in a wide range without losing degrees of freedom of construction. In this manner, even if ropes for worker and ropes for the transport cargo are provided as in this embodiment, the worker can perform construction work in a wide range without losing the freedom of construction. Further, if a spatial position is biased during reconnection, the horizontal vector will be large. Therefore, the mobile auxiliary ropes can be respectively attached to the worker sides of 3A to 3C, and a transfer method in which the connection of all three ropes is intact at the time of reconnection can be adopted.

### Fifth Embodiment

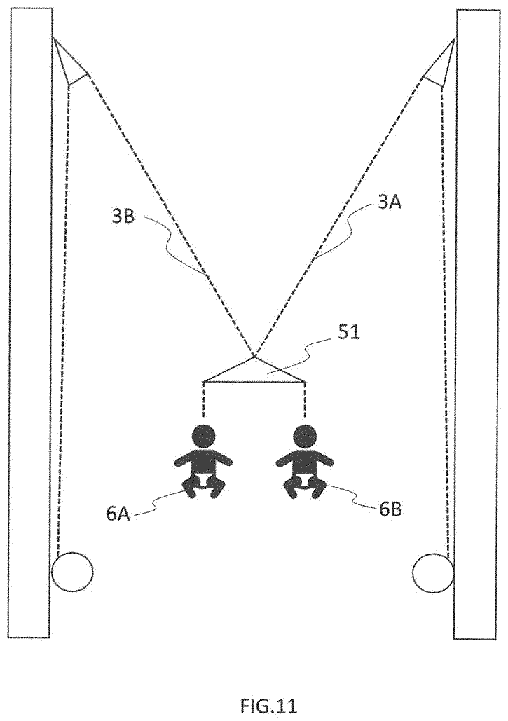

FIG. 11 is a view showing an example of the three-dimensional space construction method and system according to a fifth embodiment of the present invention. Since the configuration of the construction system of the present embodiment other than those mentioned below is basically the same as that of the first embodiment, the description thereof will be omitted.

As shown in FIG. 11, the construction system of the present embodiment is provided with a connecting member 51 connected to a plurality of workers 6A and 6B with a rope or the like so that a plurality of workers can simultaneously perform construction work, and the connecting member 51 is connected to one ends of the ropes 3A and 3B. For example, when a plurality of workers transport a large sized flat plate or the like while maintaining it in a horizontal state, and attach it to the wall of a structure, the distance between the workers connected to the connecting member 51 can be appropriately adjusted. Therefore, the worker can be attached to the connection member 51 after considering the placement of the worker according to the size of the flat plate.

### Sixth Embodiment

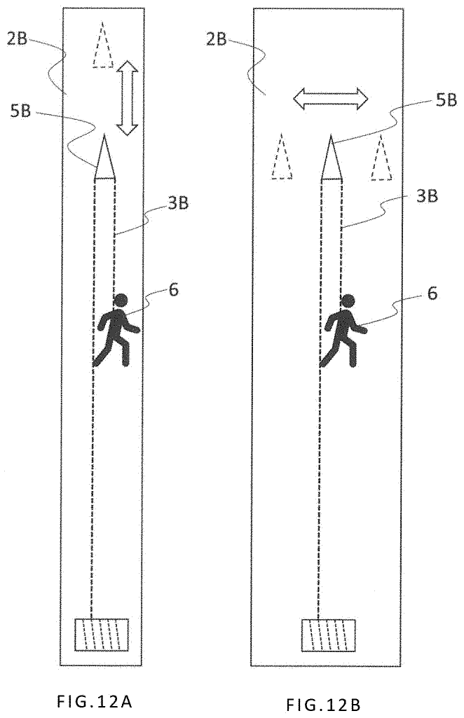

FIG. 12 is a view showing an example of the configuration of the three-dimensional space construction method and system according to a sixth embodiment of the present invention. FIG. 12 is a diagram focusing attention particularly in the vicinity of the strut 2B in the three-dimensional space construction system. As shown in each of FIGS. 12A and 12B, for example, in order to prevent airborne obstacles such as roof eaves from interfering with the rope 3B when the position of the pulley is at the area depicted by a broken line, it is possible to clear the space between the worker and the suspension point by freely moving the pulley 5B itself.

The embodiments described above are merely examples for facilitating the understanding of the present invention, and are not intended to restrictively interpret the present invention. It goes without saying that modification, improvement or the like may be made to the present invention without departing from the gist thereof, and that the present invention includes equivalents thereof.

### DESCRIPTION OF SYMBOLS

1 Three-dimensional space construction system
2A, 2B Strut
3A, 3B Rope
4A, 4B Rope winder (drum)
5A, 5B Pulleys
6 Workers
7 Controller
8 Control unit
9 Storage unit
10 Transmission/reception unit
11 Input instruction device
21 Structure

1. A three-dimensional construction method for performing construction work in a three-dimensional space, the method comprising
installing first and second pulleys at a predetermined interval in a substantially horizontal direction of a same or different structures,
installing first and second rope winders at downward positions by predetermined distances with respect to the installation positions of the first and second pulleys of the structure, and
passing first and second ropes through the first and second pulleys, respectively, one ends of the first and second ropes being connected to the first and second rope winders, respectively, and the other ends thereof being connected to a worker's wearing tool,
wherein the feeding and winding lengths and the feeding and winding speeds of the first and second ropes of the first and second winding machines, respectively, are controlled so that the worker can move to a desired position, in a space defined by positions where the first and second pulleys are installed, and positions in contact with the ground below positions where the first and second pulleys of the structure are installed.

2. The three-dimensional construction method according to claim 1, wherein the different structures are first and second struts installed substantially upright to the ground.

3. The three-dimensional construction method according to claim 2, wherein the first and second rope winders are installed at the positions contacting the ground of the first and second struts, respectively.

4. The three-dimensional construction method according to claim 2, wherein the first and second struts are connected by a third strut.

5. The three-dimensional construction method according to claim 1, wherein the method comprises:
installing third and fourth rigging pulleys at a predetermined interval in a substantially horizontal direction of the structure,
installing third and fourth rope winders at downward positions by predetermined distances with respect to the installation positions of the third and fourth pulleys of the structure, respectively, and
passing the third and fourth ropes through the third and fourth pulleys, respectively, and
wherein one ends of the third and fourth ropes are connected to the third and fourth rope winders, respectively.

6. The three-dimensional construction method according to claim 5, wherein the other ends of the third and fourth ropes are connected to a transport cargo.

7. The three-dimensional construction method according to claim 1, wherein a fixing portion for fixing a rope for preventing the worker from swinging in a direction substantially orthogonal to the space is installed at any position of a surface substantially orthogonal to the space.

8. A three-dimensional construction system for performing construction work in a three-dimensional space, comprising:
first and second rigging pulleys installed at a predetermined interval in a substantially horizontal direction on a same or different structures,
first and second rope winders installed at downward positions by predetermined distances with respect to the installation positions of the first and second pulleys of the structure, respectively,
first and second ropes passed through the first and second pulleys, respectively, and
a control device for controlling feedings and windings of the first and second ropes of the first and second rope winders, respectively, one ends of the first and second ropes being connected to the first and second rope winders, respectively, and the other ends thereof being connected to a worker's wearing tool,
wherein the control device controls the feeding and winding lengths and the feeding and winding speeds of the first and second ropes of the first and second winding machines, respectively, are controlled so that the worker can move to a desired position, in a space defined by positions where the first and second pulleys are installed, and positions in contact with the ground below positions where the first and second pulleys of the structure are installed.

9. The three-dimensional construction system according to claim 8, wherein the different structures are first and second struts installed substantially upright to the ground.

10. The three-dimensional construction system according to claim 9, wherein the first and second rope winders are installed at the positions contacting with the ground of the first and second struts, respectively.

11. The three-dimensional construction system according to claim 9, further having a third strut connecting with the first and second struts.

12. The three-dimensional construction system according to claim 8, having:
third and fourth pulleys installed at a predetermined interval in a substantially horizontal direction of the structure;
third and fourth rope winders installed at downward positions by predetermined distances with respect to the installation positions of the third and fourth pulleys of the structure, respectively, and
third and fourth ropes passed through the third and fourth pulleys, respectively, one ends of the third and fourth ropes are connected to the third and fourth rope winders, respectively.

13. The three-dimensional construction system according to claim 12, wherein the other ends of the third and fourth ropes are connected to a transport cargo.

14. The three-dimensional construction system according to claim 8, wherein a fixing portion for fixing a rope for preventing a worker from swinging in a direction substantially orthogonal to the space is installed at any position of a surface substantially orthogonal to the space.
